(19) United States
(12) Patent Application Publication
(10) Pub. No.: US 2018/0232304 A1
(43) Pub. Date: Aug. 16, 2018

(54) SYSTEM AND METHOD TO REDUCE OVERHEAD OF REFERENCE COUNTING

(71) Applicant: Futurewei Technologies, Inc., Plano, TX (US)

(72) Inventors: Haichuan Wang, San Jose, CA (US); Lin Ma, San Jose, CA (US); Ruohuang Zheng, Rochester, NY (US); Xuejun Yang, Sammamish, WA (US)

(73) Assignee: Futurewei Technologies, Inc., Plano, TX (US)

(21) Appl. No.: 15/434,270

(22) Filed: Feb. 16, 2017

(51) Int. Cl. G06F 12/02

(52) U.S. Cl. CPC G06F 12/0261; G06F 2212/69; G06F 2212/1016; G06F 12/0292

(57) ABSTRACT

The disclosure relates to technology for reference counting. A global reference counter associated with a lock to count one or more threads of a process referencing an object allocated in the memory is established. Each reference to the object by a thread is then tracked using a corresponding local reference counter. The global reference counter is updated whenever a reference to the object by each of the one or more threads is an initial reference or a final reference. Otherwise, local counters are used to track a local reference count of the object.

### BACKGROUND

Memory management systems typically keep track of memory objects after they are created and delete those objects when they are no longer needed so that the memory being used becomes available again. These systems, also known as garbage collectors, often work by maintaining a reference count that is associated with each memory object. For example, a reference count is used to keep track of objects being created or allocated, and subsequently removed, in memory. The reference count is incremented when a thread (or process or other entity) accesses or otherwise references that memory object. The reference count is decremented when the thread deletes or removes the memory object. When the reference count reaches zero, the memory object is assumed to no longer be in use and the memory manager may free the memory for re-use to thereby reduce the possibility of running out of memory.

Additionally, computing systems often have multiple processors over which a given workload may be distributed to increase computational throughput. Each processor may have an associated memory that operates at a higher speed than the main memory. When multiple threads are executing on different processors and accessing, or sharing, a common memory object, the reference count for that object will typically need to be transferred from one memory to another, which may result in increased latencies and reduced processing efficiency. As the computing system increases in size with a greater number of threads executing in parallel, the memory management may result in an increased number of reference counting instructions being issued, along with a decrease in overall system performance.

### BRIEF SUMMARY

In a first embodiment, there is a device for reference counting, comprising a non-transitory memory storage comprising instructions; and one or more processors in communication with the memory, wherein the one or more processors execute the instructions to perform operations comprising: establishing a global reference counter associated with a lock to count one or more threads of a process referencing an object allocated in the memory; tracking, by each of the threads, each reference to the object by the thread using a corresponding local reference counter; and updating the global reference counter whenever a reference to the object by each of the one or more threads is and initial reference to the object or final reference to the object.

In a second embodiment according to the first embodiment, wherein tracking, by a first thread, a reference to the object by the first thread using a corresponding local reference counter comprises determining whether the reference by the thread is an initial reference to the object; in response to determining that reference to the object is the initial reference to the object: the updating comprising increasing the global reference counter and initializing the local reference counter with a zero value; and increasing the local reference counter without locking the local reference counter.

In a third embodiment according to any one of the first through second embodiments, wherein tracking, by a first thread, a reference to the object by the first thread using a corresponding local reference counter comprises decreasing the local reference counter without locking the local reference counter; determining whether the local reference counter has a zero value; in response to determining that the local reference counter has a non-zero value, the updating comprising decreasing the global reference counter; and releasing the object from the memory when the global reference counter is updated to a zero value.

In a fourth embodiment according to any one of the first through third embodiments, a first of the one or more threads corresponds to a first local reference counter and second of the one or more threads corresponds to a second local reference counter, wherein the operations further comprise increasing the first local reference counter when the first thread references the object and decreasing the first local reference counter when the first thread no longer references the object; increasing the second local reference counter when the second thread references the object and decreasing the second local reference counter when the second thread no longer references the object; and releasing the object from the memory and the lock associated with the global reference counter when the first local counter and the second local counter have a zero value.

In a fifth embodiment according to any one of the first through fourth embodiments, the corresponding local reference counter employs a lock-free reference count.

In a sixth embodiment according to any one of the first through fifth embodiments, the global reference counter has a count value equal to a number of references by the one or more threads to the object in the memory.

In a seventh embodiment according to any one of the first through sixth embodiments, wherein the operations further comprise updating a layout of the object to include the global reference counter; and mapping an address of the object to a local address of each of the first and second corresponding local reference counters.

In an eighth embodiment according to any one of the first through seventh embodiments, wherein mapping an address of the object to a local address of each of the first and second local reference counters comprises one of (1) mapping the shared object address to addresses of the first and second local reference counters by changing associated page addresses, (2) using a hashmap to store a mapping of an address of the object to a local address of the associated reference counter, and (3) employing the first and second local reference counters when satisfying an activity level threshold for the one or more threads.

In a ninth embodiment according to any one of the first through eighth embodiments, the lock is retrieved from a lock manager and is coupled to a distributed data store to lock access to the object, grant a lock to the process for the object stored in the memory, and prevent other processes from accessing the object while locked.

In a tenth embodiment according to any one of the first through ninth embodiments, the object is a class instance of a programming language.

In an eleventh embodiment there is a computer-implemented method for reference counting, comprising establishing a global reference counter associated with a lock to count one or more threads of a process referencing an object allocated in the memory; tracking, by each of the threads, each reference to the object by the thread using a corresponding local reference counter; and updating the global reference counter whenever a reference to the object by each of the one or more threads is an initial reference to the object or a final reference to the object.

In a twelfth embodiment there is a non-transitory computer-readable medium storing computer instructions for accessing cloud-based phone services over a distributed network by a remote device, that when executed by one or more processors, perform the steps of establishing a global reference counter associated with a lock to count one or more threads of a process referencing an object allocated in the memory; tracking, by each of the threads, each reference to the object by the thread using a corresponding local reference counter; and updating the global reference counter whenever a reference to the object by each of the one or more threads is and initial reference to the object or final reference to the object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example of a distributed data system according to one embodiment.

FIGS. 2A and 2B illustrate an example of threads referencing data in a memory management system in accordance with conventional methods.

FIGS. 3A and 3B illustrate an example of threads referencing data in a memory management system in accordance with an embodiment of the disclosure.

FIG. 4 illustrates example object layouts in accordance with various embodiments of the disclosure.

FIG. 5A illustrates a flow diagram of reference counting in accordance with FIGS. 1, 3A, 3B and 4.

FIG. 5B is an example flow diagram of reference counting in accordance with FIG. 5A.

FIG. 6A illustrates one embodiment of a flow diagram for a local reference counter in accordance with FIGS. 5A and 5B.

FIG. 6B illustrates another embodiment of a flow diagram for a local reference counter in accordance with FIGS. 5A and 5B.

FIG. 7 illustrates a block diagram of a network system that can be used to implement various embodiments.

### DETAILED DESCRIPTION

The disclosure relates to technology for memory management using reference counters.

Reference counters have long been used in memory management to track the number of threads referencing (pointing to) data (an object) stored in memory. As described above, as the number of threads in a computing system increase, the memory management may result in an increased number of reference counting instructions being issued (increased overhead), along with a decrease in overall system performance.

To ensure that an object being referenced by one thread is not accessed by another thread at the same time, a locking mechanism (e.g., a semaphore) is often introduced to prevent access to the referenced object. When an object is referenced, the locking mechanism is implemented by an instruction from the system. With each instruction to lock a referenced object, additional overhead is introduced into the system.

In one embodiment, to reduce overall number of instructions and increase system performance, a global reference counter and one or more local reference counters is introduced. The global reference counter is responsible for maintain a global reference count that tracks the number of threads referencing an object. Each of the one or more local reference counters is associated with one or more threads and tracks the number of references being made to the object by the associated thread. When a reference by the thread is a first or last reference, the global reference counter is updated. Otherwise, the local reference counter is updated to reflect the reference (or exit of a reference) of the associated local thread.

In one embodiment, the global reference counter is implemented with a lock and the local reference counters are implemented in a lock-free manner. That is, updating the value of a local reference counter does not require the local reference counter to be locked in order for the update to occur.

It is understood that the present embodiments of the invention may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the invention is intended to cover alternatives, modifications and equivalents of these embodiments, which are included within the scope and spirit of the invention as defined by the appended claims. Furthermore, in the following detailed description of the present embodiments of the invention, numerous specific details are set forth in order to provide a thorough understanding. However, it will be clear to those of ordinary skill in the art that the present embodiments of the invention may be practiced without such specific details.

Various processing languages, such as Python, offer automatic reference counting or garage collection, in which memory is automatically freed when no longer in use. A general method for garbage collection in these types of languages is for the system to periodically perform a check of all objects to determine whether each object is still being referenced by thread or process. If an object is still being referenced, the object remains untouched. If, on the other hand, the object is no longer being referenced (e.g., no thread is currently referencing the object), then the system releases the object. This periodic checking behavior introduces heavy system overhead at unpredictable intervals and is therefore not an ideal solution, especially in performance sensitive environments.

Other processing languages, such as C and C++, do not typically offer automatic garbage collection, but do afford a manual mechanism in which to reference count. In these environments, object release from the memory is explicitly managed by the programmer. Reference counting provides a relatively simple garbage collection mechanism that has a constant incremental overhead. According to such a reference counting mechanism, an indicator (e.g., a counter) of some type is used to determine whether an object is being processed. While reference is being made to the object, the indicator informs the system that the object is being processed and should not be released, whereas no reference being made to the object informs the system that the object is no longer being processed and may be released.

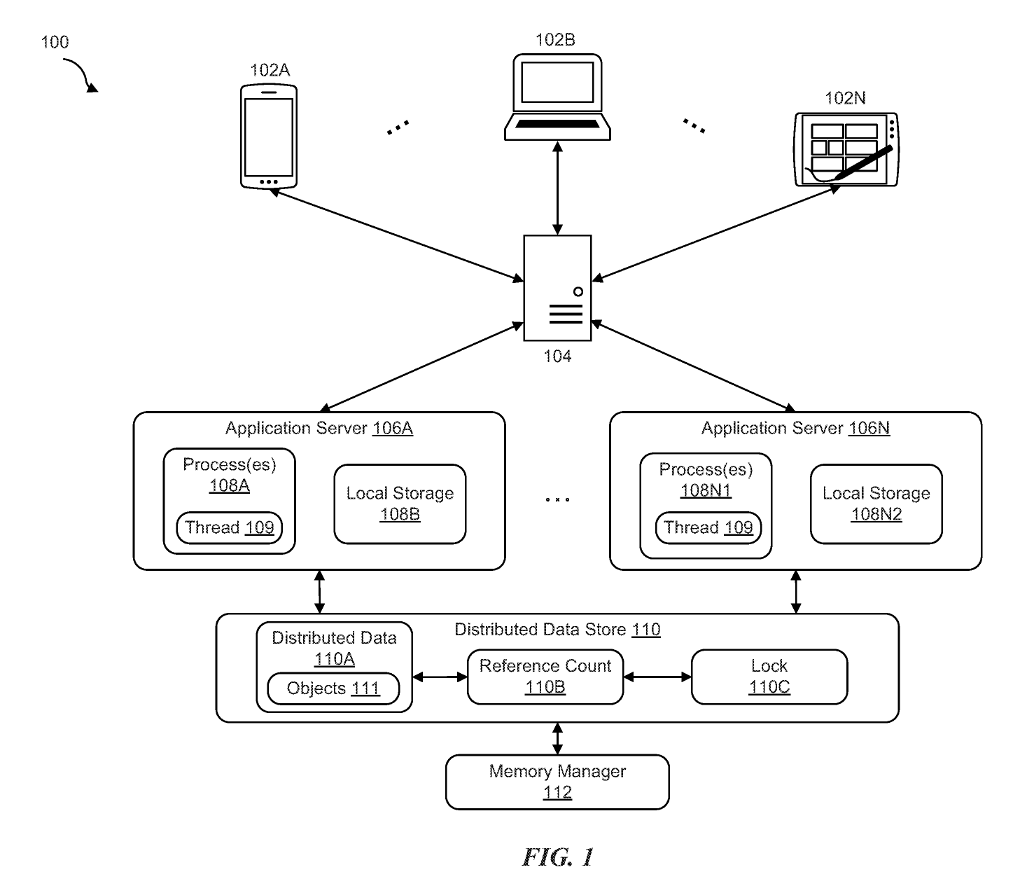

FIG. 1 illustrates an example of a distributed data system according to one embodiment. The distributed data system 100 includes, for example, client devices (or nodes) 102A-102N, server 104, application servers 106A-106N, distributed data store 110 and memory manager 112. In one embodiment, the distributed data system is a memory management system.

Clients 102A-102N may be, but are not limited to, devices such as desktop personal computers, laptops, PDAs, tablets, smartphones, point-of-sale terminals, etc. that may execute client applications, such as web browsers.

The server 104 may include one or more servers, such as an enterprise server (e.g., web server), that provide content to the clients 102A 102N via a network (not shown). The network may be a wired or wireless network or a combination thereof, and may include a LAN, WAN, Internet, or a combination thereof. Any of a variety of one or more networking protocols may be used in the network, for example, TCP/IP.

Application servers 106A-106N, which facilitate creation of web applications and an environment to execute the web applications, may include processes (or applications) 108A-108N1 and local storage 108B-108N2, respectively. In one example, the processes 108A-108N1 may be used by the clients 102A-102N to apply logic to distributed data stored in local storage 108B-108N2, respectively. Processes 108A-108N1 may include one or more threads 109.

Threads 109 (or code modules) execute on the multiple cores of application servers 106A-106N and may be configured to enter a transaction when accessing objects 111 in memory. During the transaction, the threads 109 may perform an access of the reference count 1106 associated with the object 111.

Local storage 108B may, for example, include local instances of data or objects of the distributed data maintained by the application servers 106A-106N, for example, for use by local clients of the application servers 106A-106N or by processes 108A-108N1 executing within the application servers 106A-106N.

Distributed data store 110 includes, for example, data structure 110A, reference count 110B and lock 110C. The distributed data store 110 may store data including one or more instances of distributed data 110A, where distributed data 110A may include an instance of the distributed data that is accessible by the application servers 106A-106N. In one embodiment, distributed data 110A may be distributed on the distributed data system across one or more computer-accessible mediums. In another embodiment, distributed data store 110 may include storage on one or more computer systems that also host one or more of application servers 106A 106N.

In one embodiment, the processes 108A-108N1 may provide data and/or services to enterprise server 104, for example, for use by the clients 102A-102N. The application servers 106A-106N may send updates of distributed data to distributed data store 110 in response to an event, such as a modification of one or more attributes of the local data in local storages 108A 0 108N, and/or as routine maintenance to synchronize the distributed data with the local data. In one embodiment, an attribute may be a portion or element of the distributed data, and may be one of any of various types of data that may be used in a process such as programming language objects or classes (e.g., Java objects or classes), strings, integers, Booleans, characters, real number representations, or any other type of computer-representable data.

Distributed data store 110 may also include a lock 110C, in which the lock 1100 may grant or deny access to processes 108A-108N1 for one or more portions of the distributed data 110A. Thus, when one of the processes 108A-108N1 locks one or more portions of the distributed data 110A, other processes 108A-108N1 may not access that portion. At the same time, however, other processes 108A-108N1 may lock other portions of the distributed data 110A.

In one embodiment, a process 106A-106N may hold one or more locks, with each lock 1100 corresponding to one or more portions of distributed data 110A. A thread 109 of a multithreaded process 106A-106N may request a lock 1100 for a portion of the distributed data 110A for the processing. In one embodiment, the lock 110C is implemented with a locking mechanism (not shown) that may grant the lock to the thread for processing.

In one embodiment, to access distributed data 110A, one of processes 108A-108N1 executing within an application server 104 may request a lock 1100, such as a mutex, for a portion of distributed data 110A. If another of the processes 108A-108N1 does not currently hold the lock 1100 for the same portion of distributed data 110A, the lock 1100 may be issued to the requesting process 108A or 108N1. If another process holds the lock 110C for the requested portion of distributed data 110A, the requesting process 108A or 108N1 may enter a wait state or may continue executing another task while waiting for the lock 1100 to be released.

Memory manager 112 is configured to track objects in memory after they are created and delete those objects when they are no longer needed so that the memory may be freed for reallocation. This may be accomplished by maintaining a reference count for each object allocated in memory. The reference count is incremented when a thread (code module, process or other entity) accesses or otherwise references the object in memory. The reference count is decremented when the thread no longer references the object in memory. When the reference count reaches zero, or some threshold value, the memory object may be assumed to no longer be in use and the memory manager can delete the object and free the memory associated with that object.

It is appreciated that the above described locking and protection mechanisms are non-limiting examples, and that any number of well-known locking techniques may be employed.

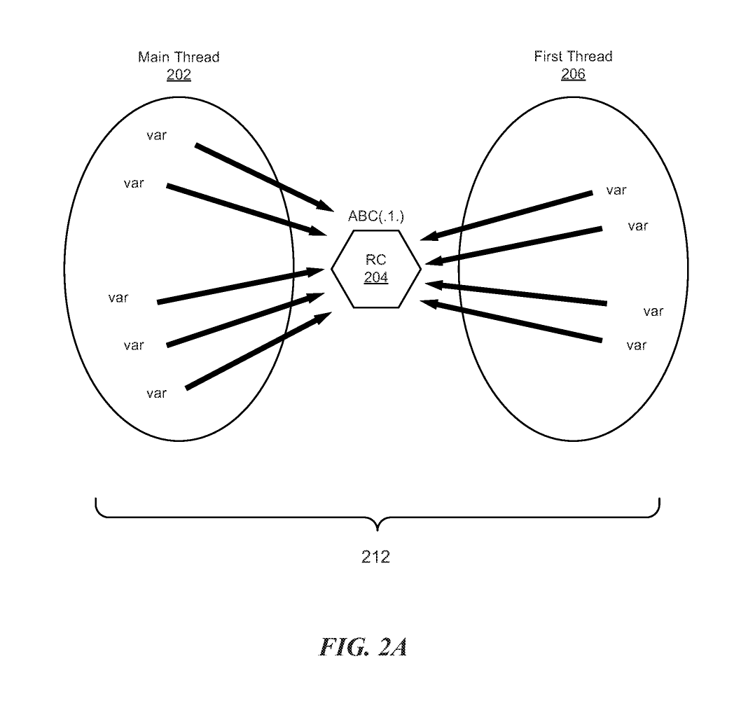

FIGS. 2A and 2B illustrate an example of threads referencing data in a memory management system in accordance with conventional methods. In particular, FIG. 2A depicts an overview of two threads of a process referencing data stored in memory of the memory management system 212. Each of the threads (main thread 202 and first thread 206) have variables that reference (or point to) data that is allocated to a particular space in memory and for which reference counter (RC) 204 tracks the number of references being made. References from a thread variable to the data stored in memory (and the associated reference counter 204) are demonstrated by the darkened arrows.

In one embodiment, the data is an object ABC(.1.) being shared by main thread 202 and first thread 206. In another embodiment, the object ABC(.1.) allocated to memory provides the functionality to maintain a reference count (a count value) using the reference counter 204. Where more than one thread 202 and 206 of the process references the object (e.g., the same or shared object) ABC(.1.), as in the depicted example, it is commonly referred to as a multithreaded process. It is appreciated, for simplicity of the discussion, that only two threads of a process and a single object and associated reference counter are being illustrated. However, any number of processes, threads, objects and/or reference counters may be employed.

To ensure that the reference counter 204 is properly updated during access by a thread 202 and 206, a locking mechanism may be employed to protect the reference counter 204 during a counter update (i.e., an increase or decrease to the count value). Implementation of a locking mechanism, in which a lock (e.g., a semaphore) is employed, is particularly useful where threads 202 and 206 of a multithreaded process request access to the same (shared) object ABC(.1.).

In one such embodiment of a locking mechanism, a thread accessing the object ABC(.1.) provides a lock instruction, which notifies other threads (threads other than 202 and 206) that the object ABC(.1.) is in use and should not be accessed. Some types of locks allow shared objects ABC(.1.) to be shared by many processes concurrently (e.g. a shared lock), while other types of locks prevent any type of lock from being granted on the same object ABC(.1.). It is appreciated that any time of well-known lock may be used, and that the disclosure is not limited to the described locking mechanisms.

Without a locking mechanism, the reference counter 204 may be updated by one thread 202 when another thread 206 is already processing the object ABC(.1.). In one example, failure to implement a lock results in a reference counter 204 update occurring in which the referenced object ABC(.1.) is prematurely released from memory while a thread is still processing the object ABC(.1.). In another example, the referenced object ABC(.1.) may not be released from memory after a thread has completed processing of the object ABC(.1.). In the former case, data processing may not be completed prior to release of the object ABC(.1.), whereas, in the latter case, the object ABC(.1.) continues to utilize space in memory even though data processing has been completed. Thus, application of the locking mechanism is imperative to ensure successful processing.

FIG. 2B illustrates an example of a multithreaded process in which main thread 202 and first thread 206 reference data (e.g., object ABC(.1.)) allocated in memory. Each reference to the object by a thread causes the reference counter 204 to be updated (e.g., increased or decreased). For example, when main thread 202 references the object ABC(.1.), the object ABC(.1.) is accessed from memory and a processing entity, such as application server 106A or 106N (FIG. 1), operates on the object ABC(.1.). To prevent other threads from accessing the same object ABC(.1.) at the same time, the afore-mentioned locking mechanism may be employed.

In the example, main thread 202 includes variables (var) ‘a,’ ‘b’ and ‘c,’ each of which reference (point to) the object ABC(.1.). As a variable references the object ABC(.1.), the reference counter 204 is increased (inc). As a variable goes out of scope (e.g., the variable is implicitly or explicitly de-allocated, or is no longer referenced by any other variable in subsequent execution), the reference counter 204 is decreased (dec).

Main thread 202 first references object ABC(.1.) with variable ‘a.’ As a result of the reference by main thread 202, the reference counter 204 is increased from an initial zero value to a count value of ‘1.’ The variable ‘a’ is then passed at 210 by the main thread 202 into the function runTask{(foo(a)}, which initiates first thread 206. The reference from first thread 206 to object ABC(.1.) with variable ‘aa’ causes the reference counter 204 to increase the reference count to a count value of ‘2.’

At this stage, multiple threads (i.e., main thread 202 and first thread 206) are being executed and any reference to the object ABC(.1.) updates the reference counter 204 of the object ABC(.1.). For example, reference by variables ‘ID’ and ‘c’ of the main thread 202 to the object ABC(.1.) respectively cause the reference counter 204 to be increased to a count value of ‘4’ and ‘6.’. As variables ‘b’ and ‘c’ complete access to the object ABC(.1.), each variable goes out of scope (“//b is dead” and “//c is dead”) and is no longer useable. This results in each variable no longer referencing the object ABC(.1.), which thereby decreases the count value (in each instance) of the reference counter 204 to a count value of ‘5.’ In one embodiment, when variable ‘a’ references a new object ABC(.20.), the reference counter 204 associated with the object ABC(.1.) is decreased since the reference to object ABC(.1.) is out of scope (“//a is redefined”).

Similarly, first thread 206 includes variables (var) ‘aa,’ ‘bb,’ ‘cc,’ ‘dd,’ ‘x,’ ‘y,’ ‘z’ and ‘u’ that access the object ABC(.1.). As a variable references the object ABC(.1.), the reference counter 204 is increased. As a variable goes out of scope, the reference counter 204 is decreased. For example, when variable ‘dd’ references the object ABC(.1.), the reference counter 204 is increased to a count value of 6, whereas when variable ‘bb’ goes out of scope the reference count 204 is decreased since variable ‘bb’ goes out of scope (“//bb is dead”). When the last variable, in this example variable ‘u,’ goes out of scope, the count value of the reference counter 204 is decreased to a zero value, and the object ABC(.1.) is released.

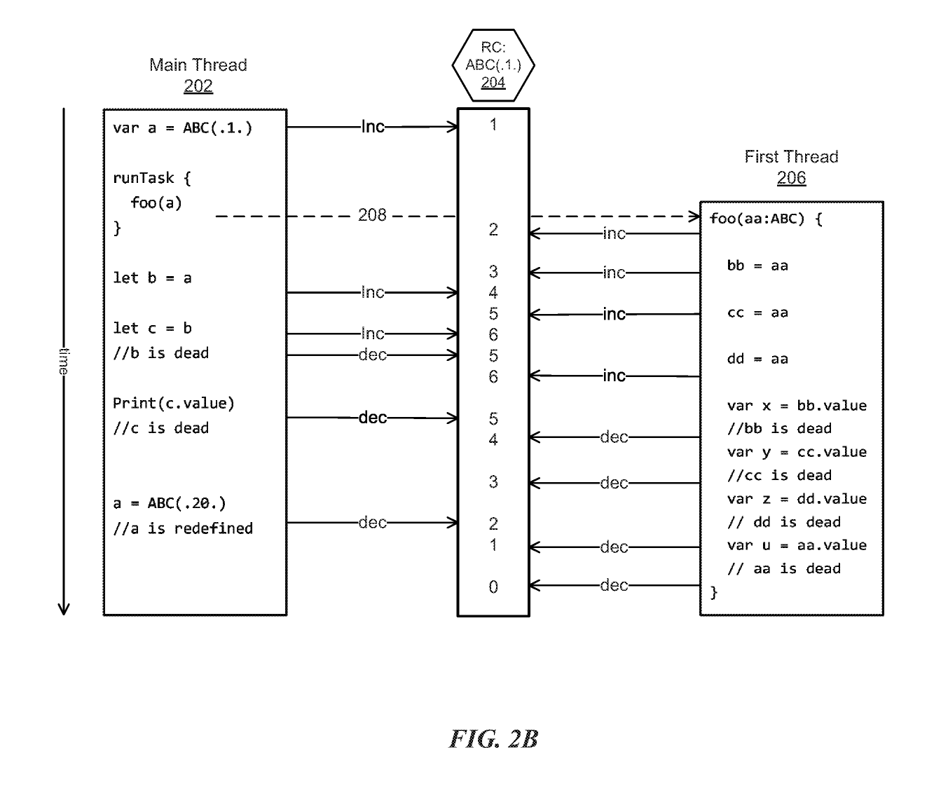

FIGS. 3A and 3B illustrate an example of threads referencing data in a memory management system in accordance with an embodiment of the disclosure. While the conventional method of referencing data in memory has many benefits, each time an object stored in memory is referenced, a lock instruction is employed by the system. As the number of references to the object increases, a significant amount overhead is also generated. That is, as the number of references increases, the number of lock instructions associated with the reference also increases.

FIG. 3A illustrates an example overview of two threads of a process referencing data stored in memory. Main thread 302 and first thread 306 of a process, similar to the embodiment of FIG. 2A, have variables (var) that reference (or point to) data that is allocated to a particular space in memory and for which a reference counter tracks the number of references being made. However, unlike the conventional method, the memory management system 312 of FIG. 3A employs three reference counters RC_{G} 304, RCₘₙ 308 and RC_{ft} 310.

In one embodiment of the memory management system 312, a global reference counter RC_{G} 304 is created when the object ABC(.1.) is allocated to memory. The global reference counter RC_{G} 304 tracks references from main thread 302 and first thread 306 when the reference is a first reference 302A and 306A to the object ABC(.1.) or a last reference 302B and 306B to the object ABC(.1.). Accordingly, the global reference counter RC_{G} 304 tracks initiation of a thread (first reference) and exiting (going out of scope, or last reference) of a thread. In one embodiment, references made to the global reference counter RC_{G} 304 employ the afore-mentioned locking mechanism and are demonstrated by dark arrows.

In addition to the global reference counter RC_{G} 304, each of the main thread 302 and the first thread 306 initiate a local reference counter RCₘₙ 308 and RC_{ft} 310, respectively, that assumes part of the reference counting operations for the object ABC(.1.). In one embodiment, when the main thread 302 or first thread 306 references the object ABC(.1.), the associated local thread counter RCₘₙ 308 and RC_{ft} 310 is updated (e.g., increased or decreased) as opposed to the global reference counter RC_{G} 304. Unlike the global reference counter RC_{G} 304, each of the local reference counters RCₘₙ 308 and RC_{ft} 310 are respectively updated when the main thread 302 or first thread 306 reference the object ABC(.1.) other than during the first or last reference. In another embodiment, only active threads (i.e., threads meeting or exceeding a threshold of activity) create a local reference counter, whereas all other, non-active threads (i.e., threads failing to meet the threshold of activity) utilize the global reference counter RC_{G} 304.

In one embodiment, references made to the local reference counters RCₘₙ 308 and RC_{ft} 310 operate in a lock-free manner. An object is considered lock-free if it guarantees that in a system with multiple threads attempting to perform operations on the object, some thread will complete an operation successfully in a finite number of system steps even with the possibility of arbitrary thread delays, provided that not all threads are delayed indefinitely (i.e., some thread completes operation).

By virtue of the lock-free operation, a lock instruction is not required in order to update the respective local reference counter RCₘₙ 308 and RC_{ft} 310, thereby saving a significant amount of overhead. That is, by implementation of a lock-free counting mechanism, problems associated with locking, including performance bottlenecks, susceptibility to delays and failures, design complications and, in real-time systems, priority inversion, may be avoided.

FIG. 3B illustrates an example of a multithreaded process in which main thread 302 and first thread 306 reference data (e.g., object ABC(.1.)) allocated in memory. When the object ABC(.1.) is initially created, the global reference counter RC_{G} 304 is also created. As noted above, the global reference counter RC_{G} 304 provides a reference count for the number of threads currently accessing the object ABC(.1.). That is, the global reference counter RC_{G} 304 equals the number of threads accessing the object ABC(.1.) at any point in time. Each first or last reference to the object ABC(.1.) by a thread causes the reference counter 204 to be updated (e.g., increased or decreased). For example, when main thread 302 first references the object (var a=ABC(.1.)), the global reference counter RC_{G} 304 is increased from a zero value to a count value of ‘1.’ Similarly, and after main thread 302 passes variable a to first thread 306 via runTask{foo(a)} at 310, when first thread 306 first references the object (foo(aa:ABC)), the global reference counter RC_{G} 304 is increased from a count value of ‘1’ to a count value of ‘2.’ In one embodiment, to prevent another threads from accessing the same object ABC(.1.) at the same time, the afore-mentioned locking mechanism may be employed.

During the first reference to the object ABC(.1.) by the main thread 302 and first thread 306, a respective local reference counter RCₘₙ 308 and RC_{ft} 310 is initialized. Once the local reference counters RCₘₙ 308 and RC_{ft} 310 are initialized, subsequent updates are performed to the local reference counter RCₘₙ 308 and RC_{ft} 310. For example, when main thread 302 first references the object (var a=ABC(.1.)), local reference counter RCₘₙ 308 is initialized and increased by a count of ‘1.’ Subsequent references to the object ABC(.1.) also update (e.g., increase or decrease) the local reference counter RCₘₙ 308 by a count of ‘1’ in a manner similar to the implementation described above with respect to FIG. 2B, and is not repeated herein. Similarly, when main thread 306 first references the object (foo(aa:ABC)), local reference counter RC_{ft} 310 is initialized and increased by a count of ‘1.’ Subsequent references also update the local reference counter RCₘₙ 310 by a count of ‘1.’

In another embodiment, when the main thread 302 and first thread 306 reference the object ABC(.1.) as a last reference, the local reference counter RCₘₙ 308 and RC_{ft} 310 for the respective thread is decreased to a zero value. For example, when main thread 302 redefines variable ‘a’ to reference object ABC(.2) (var a=ABC(.2.)), the local reference counter RCₘₙ 308 is decreased to a zero count value, thereby causing the main thread 302 to reference the global reference counter RC_{G} 304 to decrease the count value to ‘1.’ Similarly, when the last variable (var u) in first thread 306 goes out of scope (//aa is dead), the local reference counter RC_{ft} 310 is decreased to a zero count vale, thereby causing the first thread 306 to reference the global reference counter RC_{G} 304 to decrease the count value to ‘0,’ at which time the object ABC(.1.) may be released from memory.

As noted above, references to the local reference counters are performed in a lock-free manner, whereas references to the global counter are performed using the locking mechanism.

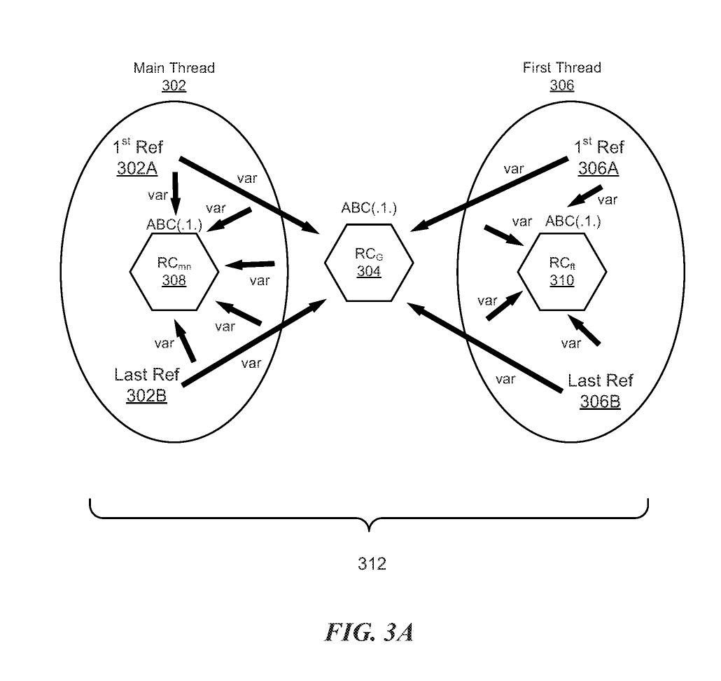

FIG. 4 illustrates example object layouts in accordance with various embodiments of the disclosure. A program in an object oriented language, such as C++, combines data and instructions or methods that operate on the data into a single unit, namely the object. The methods and variables for a particular object are defined by a class template. During the running of the program, memory space can be unnecessarily occupied by objects that are no longer used. As discussed above, an automatic mechanism to reclaim memory space may be implemented by associating a reference counter with each object that is the target of a reference from another object. Using such a mechanism, when the reference counter returns to a zero value, the target object is destroyed and the memory space containing the object is released.

In the conventional memory management system of FIGS. 2A and 2B, the class layout (or template) 402 of the object in memory includes the object type 402A, reference counter 402B and various other fields, such as metadata 402C and content 402D. To implement the memory management system including both a global reference counter and local reference counter, as described with reference to FIGS. 3A and 3B, the object layout 402 is transformed into a new object layout 404. The new object layout 404 includes object type ID 404A, global reference counter 404B which replaces the reference counter 403B of object layout 402, metadata 402C and content 402D.

In one embodiment, the new object 404 address is mapped to a storage 406 including thread local counter storage 406A which contains one or more counters, such as counter 1 406B and counter 2 406C. Mapping the address of the object to a local address of each of the first and second local reference counters (counter 1 406B and counter 2 406C), includes, but is not limited to, the following:

(1) Direct mapping: The object address is mapped to the first and second local reference counter (counter1 406B and counter2 406C) addresses by changing the associated page addresses. For example, assume for purposes of discussion that a variable points to the object in memory with an address of ‘1234,’ where ‘12’ represents the page address and ‘34’ represents the reference counter page offset. When a first thread associated with counter1 406B is created with a local address ‘88,’ the page address ‘1234’ may be mapped into the local thread address to become ‘8834’ (the address where the local counter1 406B is stored). A similar mapping may be implemented for coutner2 406C.

(2) Hashmap: Applying a hashmap to store an address of the object to a local address of the associated local reference counter. For example, for purposes of discussion, we assume an object address 1234. A hashmap is stored in a thread. When the thread accesses an associated local reference counter, the object address 1234 is input into the stored hashmap. The output of the hashmap will generate the local reference counter address for the associated thread; and

(3) Active threads: For purposes of discussion, assume there are one hundred threads executing, in which two of the one hundred threads are actively referencing objects stored in memory. Active, as the term is used herein, refers to a thread meeting or exceeding a threshold of activity. Active threads will employ the new object layout in a global reference counter and local reference counters are employed. For the two active threads, a respective hashmap is stored for those two threads, as described above. Otherwise, each of the other ninety-eight non-active threads implement the conventional reference counting method.

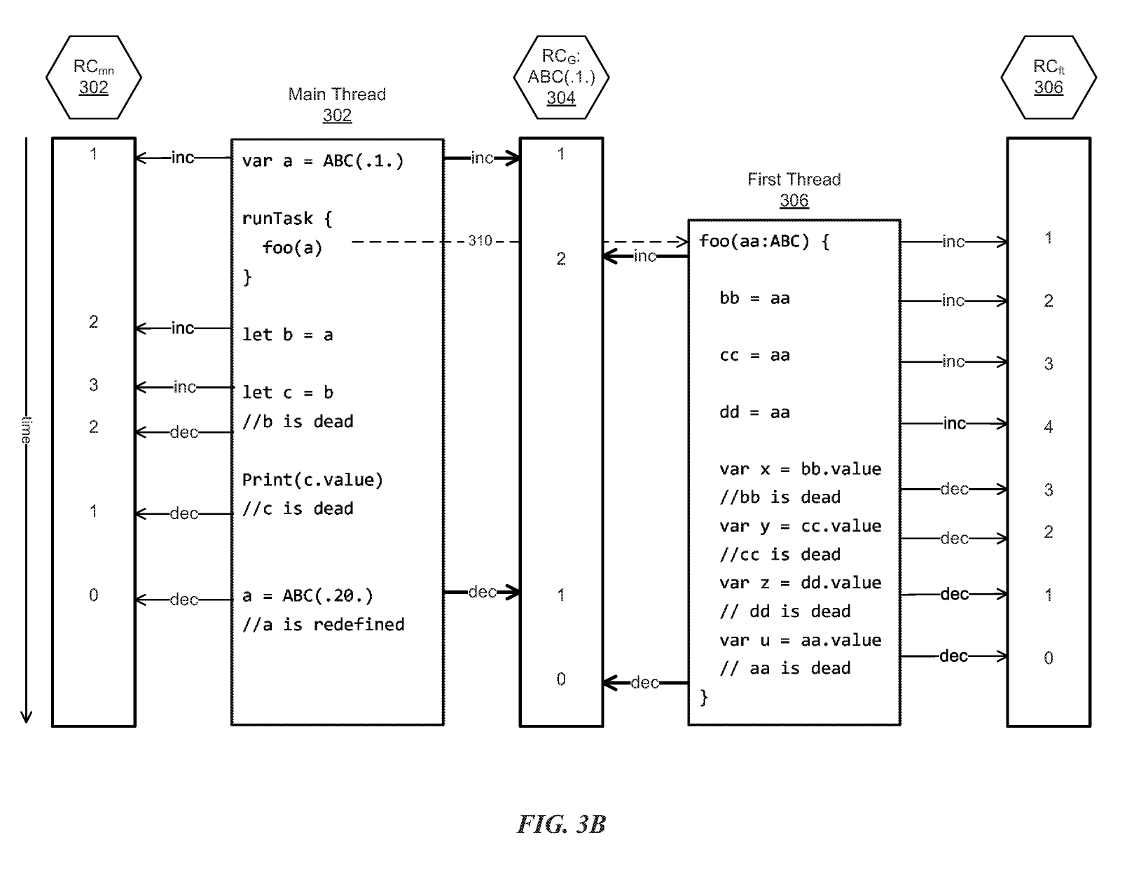

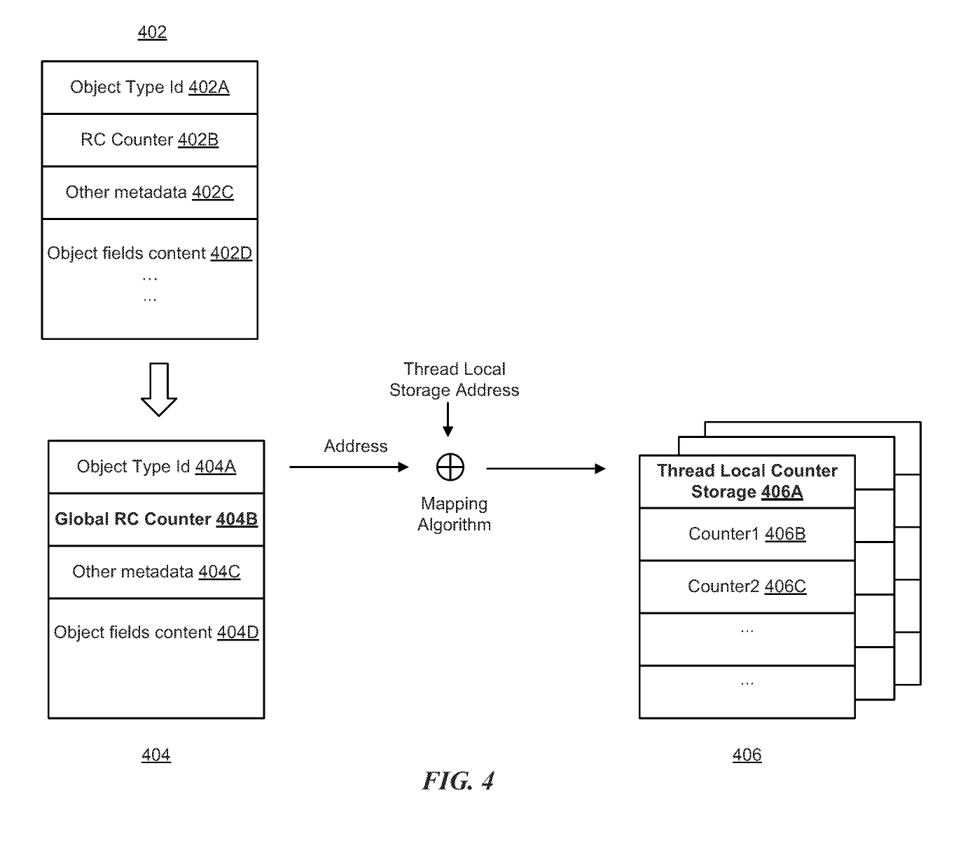

FIG. 5A illustrates a flow diagram of reference counting in accordance with FIGS. 1, 3A, 3B and 4. The methodology disclosed in the flow diagrams that follow may be implemented, in one non-limiting embodiment, by an application server 106N (FIG. 1). The application server 106N may be responsible for executing threads of a process that access a distributed data store containing objects for processing. However, it is appreciated that implementation is not limited to the application server, and that any of the various components depicted in FIG. 1 may be responsible for processing the disclosed methodology.

At 502, when an object ABC(.1.) is created and allocated to memory, a global reference counter RC_{G} 304 is set to count the number of threads referencing (pointing to) the object. The global reference counter RC_{G} 304, as explained above, tracks references being made by the threads to the object when the reference is either a first reference 302A/302B or last reference 302B/306B. The count value of the global reference counter RC_{G} 304 is updated (e.g., increased or decreased) depending on whether the reference is a first reference 302A/306A (increase the count value) or a last reference 302B/306B (decrease the count value). In one embodiment, a locking mechanism is employed to protect updates to the global reference counter.

When a first reference 302A/306A is being made to the object ABC(.1.) by a thread, a local reference counter is also created and initiated. The local reference counter, such as local reference counter RCₘₙ 308 or RC_{ft} 310, tracks (counts) references made to the object ABC(.1.) by each thread, where the reference is not a first reference 302A/306A or last reference 302B/306B. In one embodiment, the local reference counters are employed in a lock-free manner.

If reference by the thread to access the object is a first reference 302A/306A or last reference 302B/306B, as determined in 506, then the process proceeds to 508 where the global reference counter RC_{G} 304 is updated. If reference by the thread to access the object is not a first reference 302A/306A or last reference 302B/306B, then the local reference counter is updated to increase or decrease the count value at 509.

FIG. 5B is an example flow diagram of reference counting in accordance with FIG. 5A. The local reference counter, such as local reference counters RCₘₙ 308 or RC_{ft} 310, is updated at 509 in FIG. 5A in response to determining that a reference to the object is not a first reference 302A/306A or last reference 302B/306B.

At 510, the update increases local reference counter RCₘₙ 308 when the object ABC(.1.) is referenced by the main thread 302 and decreases the local reference counter RCₘₙ 308 when the main thread 302 completes its reference (goes out of scope) to the object ABC(.1.).

At 512, the update increases local reference counter RC_{ft} 310 when the object ABC(.1.) is referenced by the first thread 306 and decreases the local reference counter RC_{ft} 310 when the first thread 306 completes its reference (goes out of scope) to the object ABC(.1.).

At 514, once both of the local reference counters RCₘₙ 308 and RC_{ft} 310 have reached a zero count value, the global reference counter RC_{G} 304 will also have reached a zero count value and the object allocated to memory, along with the associated lock, will be released.

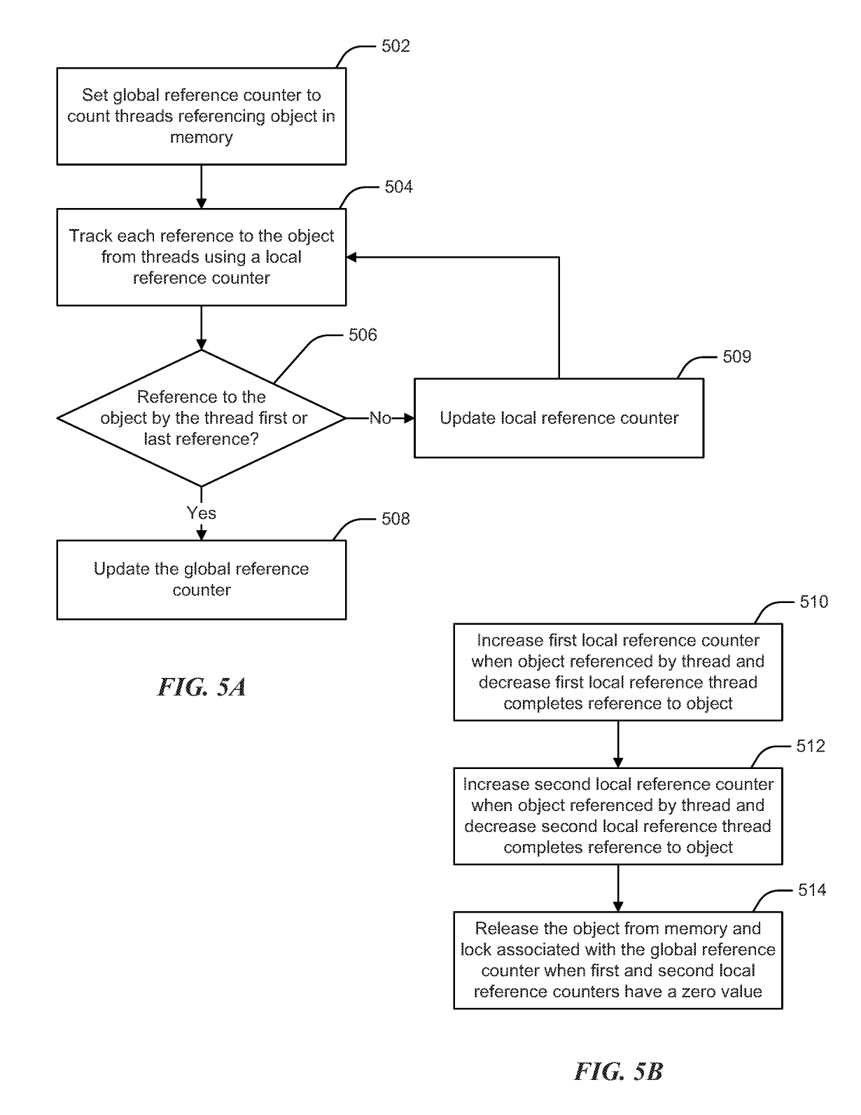

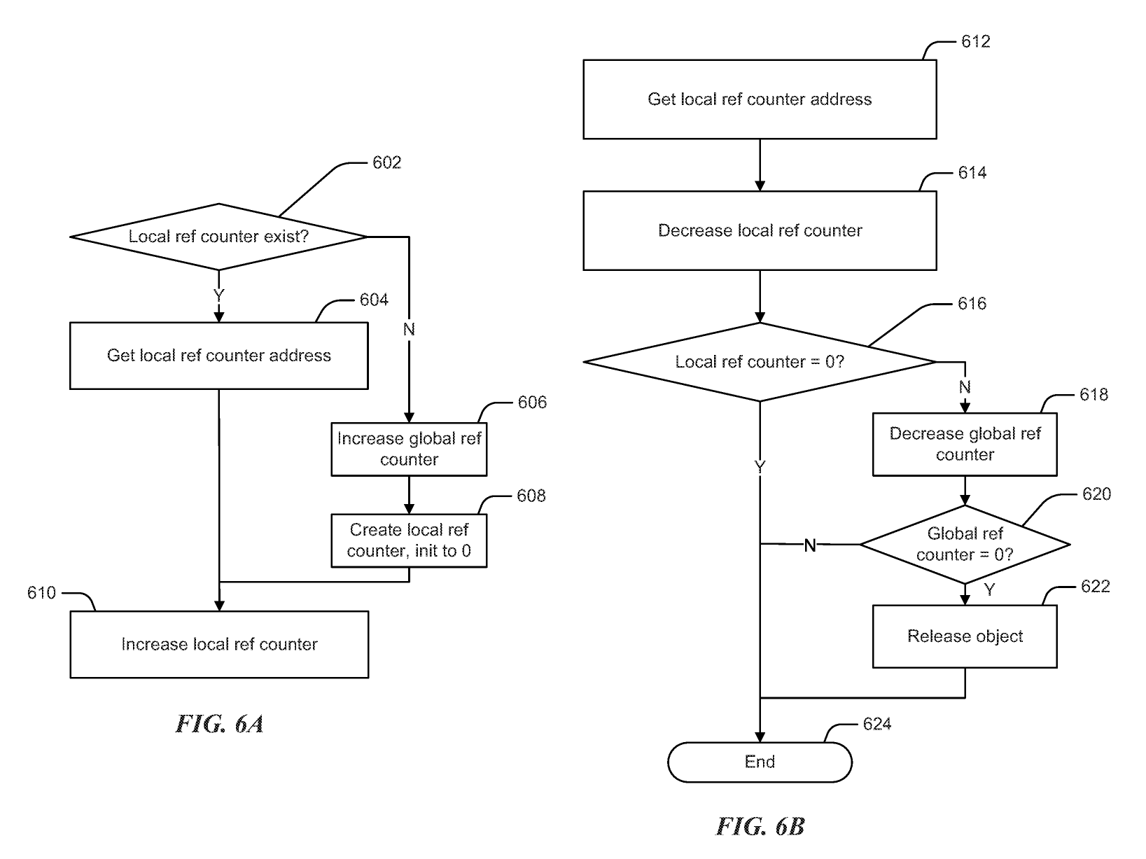

FIG. 6A illustrates one embodiment of a flow diagram for a local reference counter in accordance with FIGS. 5A and 5B. In particular, the flow diagram demonstrates the methodology of increasing a local reference counter, such as local reference counters RCₘₙ 308 and RC_{ft}.

At 602, the application server 106N (or any other component in the memory management system of FIG. 1) determines whether a local reference counter RCₘₙ 308 or RC_{ft} exists for a particular thread, such as main thread 302 or first thread 306, accessing the object. If a local reference counter RCₘₙ 308 or RC_{ft} exists, the process proceeds to 604, where the address of the local reference counter RCₘₙ 308 or RC_{ft} 310 is acquired, and the local reference counter RCₘₙ 308 and RC_{ft} 310 is increased at 610.

If the application server 106N (or any other component in the memory management system of FIG. 1) determines that a local reference counter RCₘₙ 308 and RC_{ft} 310 does not exist, the process proceeds to 606 where the global reference counter RC_{G} 304 is increased. As explained above, since no local reference counter RCₘₙ 308 and RC_{ft} 310 exists, the thread reference is considered a first reference 302A/306A, thereby increasing the global reference counter RC_{G} 304.

At 608, a local reference counter RCₘₙ 308 and RC_{ft} 310 is created and initialized to a zero value, followed by an increase to the local reference counter RCₘₙ 308 and RC_{ft} 310 t 610 (to acknowledge the first reference).

FIG. 6B illustrates another embodiment of a flow diagram for a local reference counter in accordance with FIGS. 5A and 5B. In particular, the flow diagram demonstrates the methodology of decreasing a local reference counter, such as local reference counters RCₘₙ 308 and RC_{ft} 310.

At 612, when thread, such as main thread 302 or first thread 306, references the object ABC(.1.), the respective local reference counter address is retrieved, and the local reference counter RCₘₙ 308 or RC_{ft} 310 is decreased at 614.

If the application server 106N (or any other component in the memory management system of FIG. 1) determines the local reference counter RCₘₙ 308 or RC_{ft} 310 does not have a zero count value (non-zero count value) after being decreased at 616, the process (method) ends at 624, as the thread is still referencing the object ABC(.1.).

If the application server 106N (or any other component in the memory management system of FIG. 1) determines the local reference counter RCₘₙ 308 or RC_{ft} 310 is a zero value after being decreased at 616, the process (method) continues to 618 where the global reference counter RC_{G} 304 is decreased since the local reference counter RCₘₙ 308 or RC_{ft} 310 having a zero count value implies a last reference 302B/306B (i.e., the thread referencing the object is going out of scope).

At 620, the global reference counter RC_{G} 304 is checked to determine whether the reverence count has a zero value. If the reference count does not equal a zero value, then the process (method) proceeds to 624, as described above. Otherwise, if the reference count has a zero value, then the object ABC(.1.) is no longer being referenced by any thread (i.e., all local reference counters have a zero count value), and the object ABC(.1.) is related at 622. The process (method) then completes at 624.

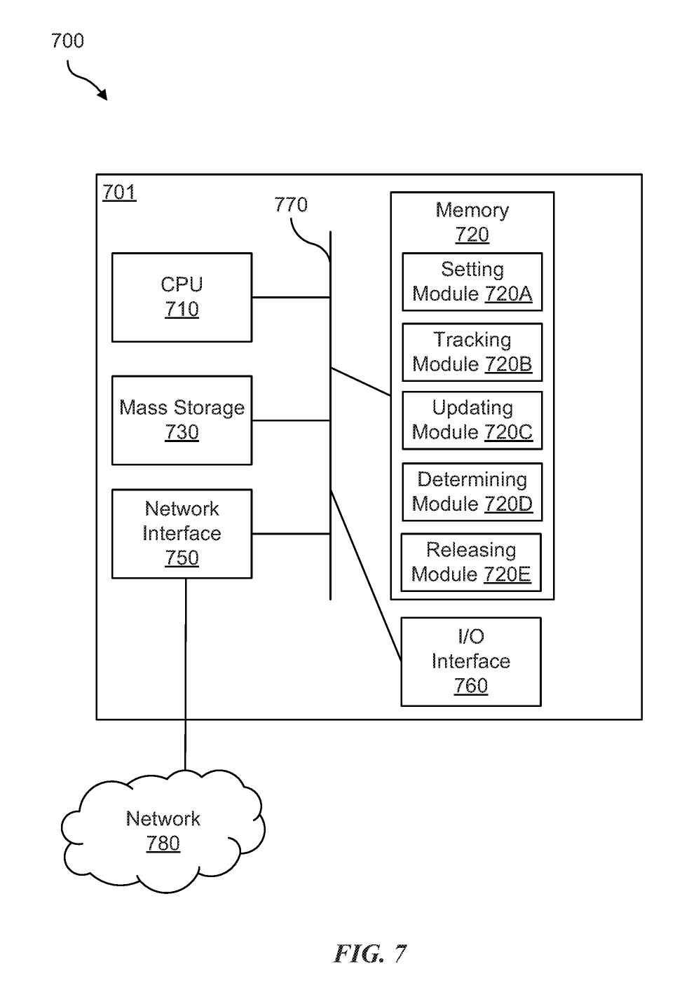

FIG. 7 is a block diagram of a network device 700 that can be used to implement various embodiments. Specific network devices may utilize all of the components shown, or only a subset of the components, and levels of integration may vary from device to device. Furthermore, the network device 700 may contain multiple instances of a component, such as multiple processing units, processors, memories, transmitters, receivers, etc. The network device 700 may comprise a processing unit 701 equipped with one or more input/output devices, such as network interfaces, storage interfaces, and the like. The processing unit 701 may include a central processing unit (CPU) 710, a memory 720, a mass storage device 730, and an I/O interface 760 connected to a bus 770. The bus 770 may be one or more of any type of several bus architectures including a memory bus or memory controller, a peripheral bus or the like.

The CPU 710 may comprise any type of electronic data processor. The memory 720 may comprise any type of system memory such as static random access memory (SRAM), dynamic random access memory (DRAM), synchronous DRAM (SDRAM), read-only memory (ROM), a combination thereof, or the like. In an embodiment, the memory 720 may include ROM for use at boot-up, and DRAM for program and data storage for use while executing programs. In embodiments, the memory 720 is non-transitory. In one embodiment, the memory 720 includes a setting module 702A to set a global reference counter associated with a lock to count one or more threads of a process referencing an object allocated in the memory, a tracking module to track each reference to the object from the one or more threads using a corresponding local reference counter, an updating module to update the global reference counter when the tracked reference to the object by each of the one or more threads is a first reference or last reference, and a releasing module to release the object from the memory when the global reference counter is updated to a zero value.

The mass storage device 730 may comprise any type of storage device configured to store data, programs, and other information and to make the data, programs, and other information accessible via the bus 770. The mass storage device 730 may comprise, for example, one or more of a solid state drive, hard disk drive, a magnetic disk drive, an optical disk drive, or the like.

The processing unit 701 also includes one or more network interfaces 750, which may comprise wired links, such as an Ethernet cable or the like, and/or wireless links to access nodes or one or more networks 780. The network interface 750 allows the processing unit 701 to communicate with remote units via the networks 780. For example, the network interface 750 may provide wireless communication via one or more transmitters/transmit antennas and one or more receivers/receive antennas. In an embodiment, the processing unit 701 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An device for reference counting, comprising:
a non-transitory memory storage comprising instructions; and
one or more processors in communication with the memory, wherein the one or more processors execute the instructions to perform operations comprising:
establishing a global reference counter associated with a lock to count one or more threads of a process referencing an object allocated in the memory;
tracking, by each of the threads, each reference to the object by the thread using a corresponding local reference counter; and
updating the global reference counter whenever a reference to the object by each of the one or more threads is and initial reference to the object or final reference to the object.

2. The device of claim 1, wherein tracking, by a first thread, a reference to the object by the first thread using a corresponding local reference counter comprises:
determining whether the reference by the thread is the initial reference to the object;
in response to determining that reference to the object is the initial reference to the object:
the updating comprising increasing the global reference counter and initializing the local reference counter with a zero value;
and
increasing the local reference counter without locking the local reference counter.

3. The device of claim 1, wherein tracking, by a first thread, a reference to the object by the first thread using a corresponding local reference counter comprises:
decreasing the local reference counter without locking the local reference counter;
determining whether the local reference counter has a zero value;
in response to determining that the local reference counter has a non-zero value, the updating comprising decreasing the global reference counter; and
releasing the object from the memory when the global reference counter is updated to a zero value.

4. The device of claim 1, wherein a first of the one or more threads corresponds to a first local reference counter and second of the one or more threads corresponds to a second local reference counter, and wherein the operations further comprise:
increasing the first local reference counter when the first thread references the object and decreasing the first local reference counter when the first thread no longer references the object;
increasing the second local reference counter when the second thread references the object and decreasing the second local reference counter when the second thread no longer references the object; and
releasing the object from the memory and the lock associated with the global reference counter when the first local counter and the second local counter have a zero value.

5. The device of claim 1, wherein the corresponding local reference counter employs a lock-free reference count.

6. The device of claim 1, wherein the global reference counter has a count value equal to a number of references by the one or more threads to the object in the memory.

7. The device of claim 4, wherein the operations further comprise:
updating a layout of the object to include the global reference counter; and
mapping an address of the object to a local address of each of the first and second corresponding local reference counters.

8. The device of claim 7, wherein mapping an address of the object to a local address of each of the first and second local reference counters comprises one of:
(1) mapping the shared object address to addresses of the first and second local reference counters by changing associated page addresses,
(2) using a hashmap to store a mapping of an address of the object to a local address of the associated reference counter, and
(3) employing the first and second local reference counters when satisfying an activity level threshold for the one or more threads.

9. The device of claim 1, wherein the lock is retrieved from a lock manager and is coupled to a distributed data store to
lock access to the object,
grant a lock to the process for the object stored in the memory, and
prevent other processes from accessing the object while locked.

10. The device of claim 7, wherein the object is a class instance of a programming language.

11. A computer-implemented method for reference counting, comprising:
establishing a global reference counter associated with a lock to count one or more threads of a process referencing an object allocated in the memory;
tracking, by each of the threads, each reference to the object by the thread using a corresponding local reference counter; and
updating the global reference counter whenever a reference to the object by each of the one or more threads is an initial reference to the object or a final reference to the object.

12. The method of claim 11, wherein tracking, by a first thread, a reference to the object by the first thread using a corresponding local reference counter comprises:
determining whether the reference by the thread is the initial reference to the object;
in response to determining that reference to the object is the initial reference to the object:
the updating comprises increasing the global reference counter and initializing the local reference counter with a zero value; and
increasing the local reference counter without locking the local reference counter.

13. The method of claim 11, wherein tracking, by a first thread, a reference to the object by the first thread using a corresponding local reference counter comprises:
decreasing the local reference counter without locking the local reference counter;
determining whether the local reference counter has a zero value;
in response to determining that the local reference counter has a non-zero value, the updating comprising decreasing the global reference counter; and
releasing the object from the memory when the global reference counter is updated to a zero value.

14. The method of claim 11, wherein a first of the one or more threads corresponds to a first local reference counter and second of the one or more threads corresponds to a second local reference counter, and further comprising:
increasing the first local reference counter when the first thread references the object and decreasing the first local reference counter when the first thread no longer references the object;
increasing the second local reference counter when the second thread references the object and decreasing the second local reference counter when the second thread no longer references the object; and
releasing the object from the memory and the lock associated with the global reference counter when the first local counter and the second local counter have a zero value.

15. The method of claim 11, wherein the corresponding local reference counter employs a lock-free reference count.

16. The method of claim 11, wherein the global reference counter has a count value equal to a number of references by the one or more threads to the object in the memory.

17. The method of claim 14, further comprising:
updating a layout of the object to include the global reference counter; and
mapping an address of the object to a local address of each of the first and second corresponding local reference counters.

18. The method of claim 17, wherein mapping an address of the object to a local address of each of the first and second local reference counters further comprises one of:
(1) mapping the shared object address to addresses of the first and second local reference counters by changing associated page addresses,
(2) using a hashmap to store a mapping of an address of the object to a local address of the associated reference counter, and
(3) employing the first and second local reference counters when satisfying an activity level threshold for the one or more threads.

19. A non-transitory computer-readable medium storing computer instructions for accessing cloud-based phone services over a distributed network by a remote device, that when executed by one or more processors, perform the steps of:
establishing a global reference counter associated with a lock to count one or more threads of a process referencing an object allocated in the memory;
tracking, by each of the threads, each reference to the object by the thread using a corresponding local reference counter; and
updating the global reference counter whenever a reference to the object by each of the one or more threads is and initial reference to the object or final reference to the object.

20. The non-transitory computer-readable medium of claim 19, wherein tracking, by a firth thread, a reference to the object by the first thread using a corresponding local reference counter, causing the one or more processors to further performs the steps of:
determining whether the reference by the thread is an initial reference to the object;
in response to determining that reference to the object is the initial reference to the object:
the updating comprising increasing the global reference counter and initializing the local reference counter with a zero value; and
increasing the local reference counter without locking the local reference counter.

21. The non-transitory computer-readable medium of claim 19, wherein tracking, by a firth thread, a reference to the object by the first thread using a corresponding local reference counter, causing the one or more processors to further performs the steps of:
decreasing the local reference counter without locking the local reference counter;
determining whether the local reference counter has a zero value;
in response to determining that the local reference counter has a non-zero value, the updating comprising decreasing the global reference counter; and
releasing the object from the memory when the global reference counter is updated to a zero value.
